(19) United States
(12) Patent Application Publication
(10) Pub. No.: US 2010/0023393 A1
(43) Pub. Date: Jan. 28, 2010

(54) ALGORITHMIC CREATION OF PERSONALIZED ADVERTISING

(75) Inventors: Theodore Costy, Warren, MI (US); Robert F. Bordley, Troy, MI (US); Kurt S. Godden, Sterling Heights, MI (US); Jonathan H. Owen, Beverly Hills, MI (US); David J. Vander Veen, Troy, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 12/502,906

(22) Filed: Jul. 14, 2009

Related U.S. Application Data
(60) Provisional application No. 61/084,127, filed on Jul. 28, 2008.

(51) Int. Cl. G06Q 30/00

(52) U.S. Cl. 705/14.43; 705/14.67; 705/14.58; 705/14.53; 705/14.62; 705/14.72; 705/14.41; 705/14.63

(57) ABSTRACT

A method for automatically creating personalized ads to target a specific individual. The method includes first identifying a potential customer who may be interested in a particular product. An automated process then learns about and understands the customer based on his location and how that person interacts with the particular medium on which the ad is going to be presented. Once the information about the customer is developed, an advertisement is created that includes a collection of ad components that identify parts of the ad that may be of interest to the customer based on the learned information. The ad components are selected from a database of available components. The advertisement is then scheduled and placed in the medium and its measure of effectiveness is determined based on the customer's reaction thereto. These measures of effectiveness are used to further refine parameters in understanding the customer and designing the ad.

### CROSS-REFERENCE TO RELATED APPLICATIONS

This application claims the benefit of the priority date of U.S. Provisional Patent Application Ser. No. 61/084,127, titled Algorithmic Creation of Personalized Advertising, filed Jul. 28, 2008.

### BACKGROUND OF THE INVENTION

This invention relates generally to a system and method for creating an advertisement and, more particularly, to a system and method for automatically creating a vehicle advertisement that is personalized for a potential customer in response to information learned about the customer.

Certain industries spend a considerable effort developing advertisements targeting potential customers. The advertising budget for automobile manufacturers is typically very high and is a considerable percentage of the actual vehicle cost so that customer awareness and consideration of their vehicles reaches a large percentage of the population. For example, customer consideration is a top driver for growing revenue and aggregate contribution margin (ACM). Advertising is provided in any suitable media, such as television, print, radio, Internet, billboards, etc.

A typical process for developing an advertisement for a particular vehicle includes a group of advertising personnel meeting to discuss the product itself and the types of ads that may be suitable for the product. Once an idea is developed from this discussion, it is prototyped and presented to the company to determine whether it is acceptable for that product. Once the ad is accepted and produced, it is distributed in a suitable medium, typically as a mass marketing campaign that reaches a large number of people. The trend, however, has been for the development of more advertisements that are reaching fewer people who are paying less attention to the ads due to new technologies, such as digital video recorders, which allow skipping of advertising. Further, advertising budgets are typically shrinking, while advertising needs are increasing.

### SUMMARY OF THE INVENTION

In accordance with the teachings of the present invention, a system and method are disclosed for automatically creating personalized ads that are intended to target a specific individual. The method includes first identifying a potential customer who may be interested in a particular product, such as a vehicle. An automated process then learns about and understands the potential customer based on his location and how that person interacts with the particular medium on which the ad is going to be presented. Once the information about the customer is developed, an advertisement is created that includes a collection of ad components where each component identifies part of the ad that may be of interest to the potential customer based on the learned information. The ad components are selected from a database of available pre-stored ad components and then collectively assembled to create the advertisement. The advertisement is then scheduled and placed in the medium, and its measure of effectiveness is determined based on the customer's reaction thereto. These measures of effectiveness are used to further refine parameters in understanding the customer and designing the ad.

Additional features of the present invention will become apparent from the following description and appended claims, taken in conjunction with the accompanying drawings.

### BRIEF DESCRIPTION OF THE DRAWINGS

FIG. 1 is a block diagram showing a method for automatically creating a personalized advertisement for a vehicle based on information learned about the person, according to one embodiment of the present invention; and

FIG. 2 is an illustration of a hierarchical ad structure with two constraints.

### DETAILED DESCRIPTION OF THE EMBODIMENTS

The following discussion of the embodiments of the invention directed to a system and method for automatically creating a personalized advertisement targeted to a specific individual is merely exemplary in nature, and is in no way intended to limit the invention or its applications or uses. For example, the discussion below concerns personalizing a vehicle advertisement. However, as will be appreciated by those skilled in the art, the system and method for creating the advertisement will have application for other products.

The creation of advertising has long been a team-based activity consisting of frequent interaction between the client and creative ad agencies. With the advent of web-based advertising, a somewhat automated methodology has been employed by which either an ad is selected from a set of pre-created, static ads or a template is filled in according to contextual information. A new paradigm is presented here by which both of these approaches are replaced with a fully-automatic creation and placement of potentially unique ads on-demand and in real time. An integral part of this process includes a formal closed-loop learning process that optimizes the effectiveness of the placement and creation of the ads by iteratively gathering data on each ad and evaluation the data against an objective function.

One embodiment of this process could be in a web-based browser where the code monitors user behavior, including links clicked, websites visited, forms filled out, and so forth. All such user interaction provides information regarding the interests as well as characteristics of that user. For example, it could be determined that one user is an avid male golfer, and another user may be identified as a retired female who enjoys gardening. Additional information might also be discovered about these users.

Once the code has gathered information on the user, an ad designed explicitly for that user can be created under program control. Continuing with the same example, the ad may extract ad elements from databases that match, either deterministically or probabilistically, the user's profile. For example, the ad may contain a background of a golf course for the one user and a home yard setting for the other user.

Additional ad elements could be extracted from a database to indicate that the ad's theme should revolve around ecologically-friendly value and family utility. Additional matches on the user profile could result in the selection of an ad that employs Beethoven's 6^{th} symphony (light classical) or golf clubs visible through the cargo area window of the vehicle that is shown in front of a backdrop of a famous golf course.

The ad's thematic elements are then matched with a text database of creative ad copy that is selected to fit the available copy space as well as mood (e.g. relaxing, comedic, etc.).

All image and text data are then composed, formatted and delivered to the user's screen dynamically. All matching and selection of ad elements, images and text can be performed probabilistically so that the same user may not see the same ad twice, even though he may be targeted by the ad generator multiple times. This also allows easy replacement of the ad content at any time by simple replacement of database contents, resulting in virtually unlimited number of ads.

Such dynamically created ads are not limited to the domain of web browsers, but could also include digital television, cell phones or other wireless devices, in-vehicle delivery systems, kiosks and any other domain that supports dynamic discovery of information regarding the target consumer and real-time creation and delivery of information.

As discussed, the present invention proposes a system and method for automatically personalizing an advertisement for a particular product for a potential customer that may be accessing a certain medium, such as the Internet, so that the advertisement can be displayed to the customer. As will be discussed below, the method includes learning about the customer based on, for example, where the customer is located and how the customer interacts with the medium, such as what web-link clicks the customer makes. Once a general understanding of the customer is developed, the advertisement is created by selecting several ad components from a database including pre-stored ad components for various ad parts that may appeal to the customer based on what is learned about him. The advertisement is then placed for the customer to see and/or hear, and closed-loop feedback is provided to determine how effective the process has been.

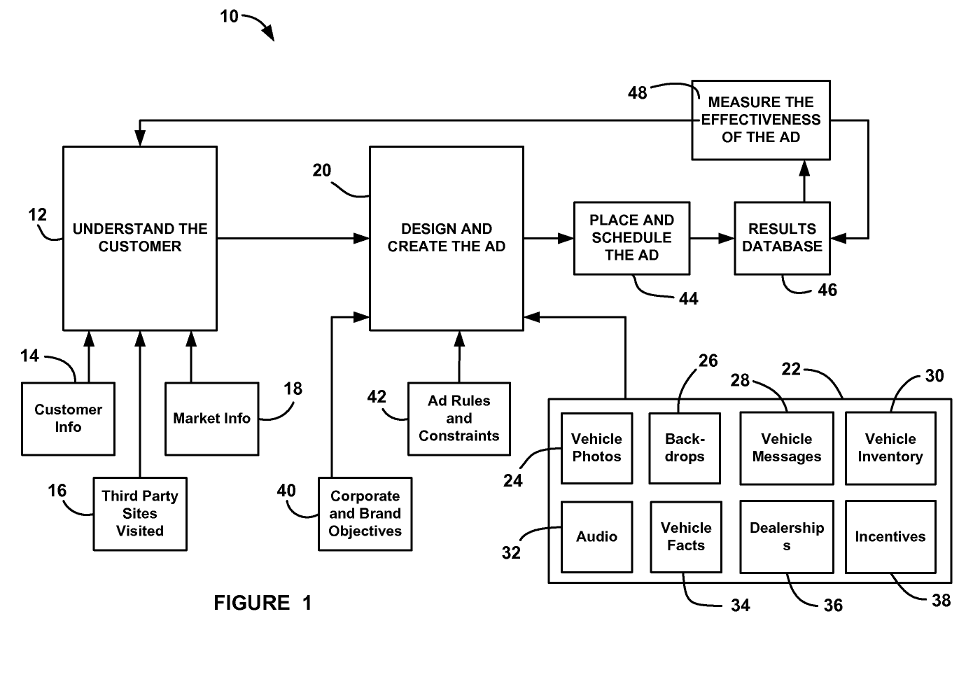

FIG. 1 is a block diagram 10 showing a method for creating such an advertisement for a vehicle as outlined above. The process employs an algorithm that automatically goes through an analysis to understand the customer at box 12 based on that customer's location and interaction with the medium. Understanding the customer can include various things, such as customer location, segment, price range and features, purchase stage, interests, language, cognitive style, past purchases, direct query responses, customer profile, registrations, geo-demographics, dealership access, etc. For example, a customer may be visiting a website on the Internet where the particular vehicle manufacturer is advertising its products. Also, the customer may be specifically looking for a vehicle, such as on Edmunds.com. In combination with the location of the potential customer, information may be gathered about the customer based on what website clicks that the customer makes. The algorithm can employ any suitable statistics analysis consistent with the discussion herein, such as neural networks or Bayesian processes.

The creation of the advertisement is based on an interaction of the person with the advertising medium, or other available human access points, so that an accurate understanding of the customer can be obtained. Further, the type of device that the customer is interacting with could provide information that goes to the understanding of the potential customer. The process of understanding the customer at the box 12 can be provided from any suitable information that can be obtained from the customer based on who that customer might be, such as age, race, religion, education, income, orientation, etc. Information about the potential customer can be obtained by what forms the customer may fill out. Further, information generated or identified to understand the customer may include purchase history, the type of vehicle the customer may be interested in, the price range of the vehicle that may be suitable for the customer, the various features that the customer may desire in the vehicle, identifying competitor vehicles that the customer may be interested in, the particular interests of the customer, the purchasing stage that the customer is in, such as just looking, ready to buy, etc., and communication style, preferences that inform how messages can be effectively presented to the customer, such as visually, textually, etc. A potential customer profile can be generated based on the information that is obtained about the customer.

Other information can also be assessed that identifies the type of potential customer that is being targeted. At box 14, information about the potential customer, such as the type of customer or personal information, can be used if that information is somehow obtainable. Also, the algorithm can use third party websites visited by the potential customer, and clicks made in the website, at box 16 as inputs to understanding the customer. Further, marketing information about the potential customer can be provided at box 18, and can include economic details about the potential customer, such as his geo-demographics, brand categories, etc. Missing or incomplete information may be inferred (or computed) at box 12 through statistical analyses of populations with characteristics that are somewhat similar to a given potential customer.

Once the information is automatically gathered, collected or identified about the potential customer at the box 12 within the scope of the particular algorithm being used, the process then designs and creates the advertisement at box 20. The several things that go into designing and creating the advertisement can include the specific vehicle to be advertised, the color of the vehicle, the background scene that the vehicle is presented in, a message that is displayed in the advertisement, such as fuel economy, any music or background sounds provided in the advertisement, any dialogue provided in the advertisement, animations in the advertisement, such as engine operation, dealership inventory, etc.

Each of the various things that are selected to create the advertisement at the box 20 comes from an ad components database 22. The ad components database 22 includes a number of pre-stored and different ad components where each component is selected from many available components that are stored in the database 22. These ad components may include vehicle photos showing different vehicle models in various positions at box 24, available back-drops or scenes at box 26, such as urban, rural, farm, beach, mountains, golf course, etc., a selection of appropriate vehicle messages at box 28, such as fuel economy, price, etc., vehicle inventory and location at box 30, audio or dialog selections that can be used with the ad at box 32, a selection of vehicle facts for the particular vehicle model selected at box 34, available dealerships at box 36 and any incentives that may be currently offered for the selected vehicle at box 38. Although the created advertisement may be a combination of these eight different ad components in one certain process, this is not intended to be an exhaustive list of the ad components that may be available and can be employed, and certainly less than eight different ad components can be employed in other ads.

Also, the creation and design of the advertisement at the box 20 may include input from ad rules and constraints box 42. For example, it may be known that certain vehicle messages and certain audio go better with certain types or models of vehicles and with each other, which could be used as a guideline or a constraint in designing the ad. Further, a particular corporation or vehicle manufacturer may have certain design objectives depending on which model or brand of vehicle is being advertised. These corporate and brand objectives can be provided at box 40 so that the design and creation of the advertisement is consistent with those corporate objectives.

Once the advertisement is designed and created at the box 20, it is then placed and scheduled on the medium at box 44 for the potential customer to view. As discussed herein, placement of the advertisement would be specific to the type of interactive medium being used, such as the Internet, cell phone, in-vehicle delivery systems, kiosks and other domains that support dynamic discovery of information regarding the target consumer and a real-time creation and delivery of information. Scheduling of the advertisement is important to determine when the ad will be placed. Benefits can be realized by simultaneously creating, placing and scheduling the advertisement.

Effectiveness data for each advertisement that is placed can be stored in a database 46 for at least some period of time. The data that is stored in the database 46 can then be assessed to provide a measure of their effectiveness at box 48. The effectiveness of any ad can also be stored in the database 46. Any suitable technique can be used to measure the effectiveness of the advertisement, such as whether the potential customer clicked the ad, resulted in a dealer lead, actually purchased a vehicle, etc. Further, the measure of effectiveness of the advertisement can be used to improve the algorithm for creating the ad by better understanding the customer at the box 12 in a closed-loop learning process. Therefore, as more ads are presented to potential customers and their effectiveness is determined, improvements can be made so that the effectiveness is increased.

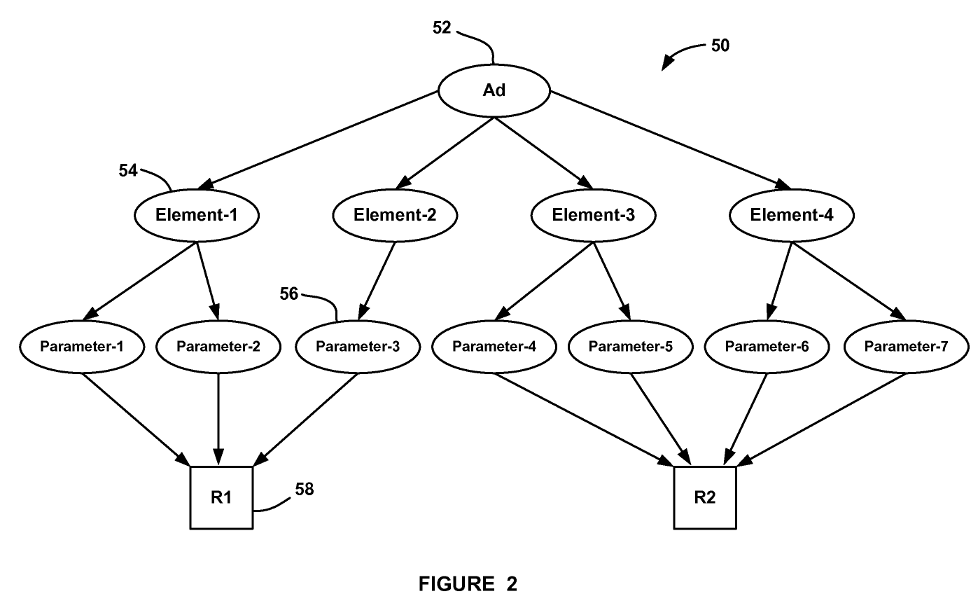

If one or more constraint relations are not satisfied, then custom routines, also stored in the database 42, are invoked to manipulate the ad data structure (primarily by modifying parameter values) until all constraints are satisfied. FIG. 2 is a hierarchical ad structure 50 for invoking custom routines where not all of the constraints are satisfied. The structure 50 shows an ad 52 that includes four elements 54. Each element 54 includes one or more parameters 56 where a number of parameters define a constraint 58. In this example, a constraint is a function of multiple parameters which equal 1 when the constraint is satisfied and 0 otherwise. For example, if R1 is the function (x, y, z)=1, where x is parameter 1, y is parameter 2 and z is parameter 3, the constraint R1 is satisfied Similarly, if constraint R2 is (w, x, y, z)=0, where w is parameter 4, x is parameter 5, y is parameter 6 and z is parameter 7, then the constraint R2 is not satisfied. In this case, a custom routine is used to modify the parameters 4-7 to satisfy the constraint R2.

In the event that not all constraints can be satisfied in reasonable time, then the construction of the current ad is terminated. In its place, either a fresh invocation of a dynamic ad may begin, time permitting, or else a template may be filled in, per existing practice.

Based on the discussion above, an example of an assembly for a vehicle ad for a particular individual can be as follows. A vehicle is selected based on a combination of buyer interests, such as segment interest, make, price, fuel economy and performance. A color can be applied to the vehicle based on a combination of buyer characteristics, such as geographic trends, current and past owned colors, and history of colors clicked, as well as selection rules, such as pallet suitability requirements for available background settings. The vehicle is placed in a back-drop based on a combination of buyer interests, such as hobbies, gender, race, location, employment, income, education, etc. A message is inserted into the ad based on a combination of buyer values, such as price, deal, fuel economy, performance, quality, technology, purchase chain stage, etc. Voice-overs or jingles can also be provided.

The discussion below outlines one non-limiting formal optimization algorithm underlying the ad creation discussed above. Other alternatives could also be provided.
(1) An enumeration of all possible locations on which an ad could be placed is developed;
(2) An enumeration of all the various elements (or aspects) of an ad including background, vehicle, attributes advertised, cognitive style used, ad focus (one vehicle only, comparison between two, etc.), jingle, theme, etc. is developed;
(3) For each ad element, an enumeration of all the choices that might be made for this ad element is developed. Thus, for ad background, there might be a farm background, small-town background, urban background, mall background, ocean background, etc.; and
(4) An enumeration of all the relevant characteristics of the user that will be used in the algorithm (e.g. for web-based users these include clickstream, user location, (e.g., as inferred by IP address), other websites visited, etc.) is developed.

Locations for ad elements, as well as locations for the ad itself, can be specified by referencing standard coordinates in pixels, either from the upper-left corner of the user's screen (for the ad itself) or from the upper-left corner of the ad's on-screen real estate (for the ad's elements).

Elements consist of any of the atomic visual or auditory characteristics of the ad, including, but not limited to foreground and background images, ad copy text for messaging, music, non-musical sounds, animations, themes, colors, product features to be advertised, type of ad (to feature one product, to compare two or more products, etc.), cognitive styles of the user, and so forth.

Each atomic ad element may be drawn from a database of existing elements which may be updated periodically. For example, product images reside in this database, as do various sets of text messages for ad copy, sound files, etc. for every type of element.

User data is represented as a vector of features which may include the user's location (e.g., as inferred by IP address), clickstream, browser type, ethnographic characteristics (if such are known), among others.

The algorithm presented here assumes a web-based delivery environment for the ad. Adaptation of this algorithm to other delivery environments (e.g. cell phones, kiosks, etc) is straightforward.

The following is one non-limiting formulation of the optimization problem for web-based delivery.
(1) Let i=1, . . . I index the possible locations on all web-pages on which an ad is placed.
(2) Let k=. . . K index the various elements types (e.g. background, vehicle, attributes, advertised, cognitive style used, jingle theme, etc) associated with an ad.
(3) Let j(k)=1 . . . maxₖ be a function from ad element types to ad element indices, where maxₖ is the number of choices for ad element k. Thus, if element type 2 refers to vehicles, then j(2)=1 means the first vehicle is being referred to, and j(2)=2 means the second vehicle is being referred to.
(4) Let c denote a vector of characteristics of the web-user. This includes explicitly claiming that one such vector can be the click stream history of the user. Also, explicitly claiming that another such vector can consist of geo-demographic characteristics of the user based on that user's location as determined by the user's IP address, and where location is represented by zip code, for example.

Other vectors of user characteristics are possible, as well.
(5) Let Rₙ for n=1, . . . ,m be a function from the K different ad elements such that Rₙ (j(1), . . . j(K))=1 if the K-tuple of elements j(1), . . . j(K) stand in relation Rₙ to one another, and equals 0 otherwise. Informally, each Rₙ is a constraint that must hold on any given set of ad elements j(1), . . . j(K) for that ad to “make sense.” A given Rₙ will typically consist of first-order logical expressions.
(6) Let B(i,j(1), . . . j(K),c) be a zero-one variable which equals 1 if an ad is placed for an individual with characteristics c at location i where the ad is composed of j(1), . . . j(K) for the various key ad elements k=1 . . . K, and where π Rₙ(j(1), . . . j(K))=1 for n=1 . . . m; that is, the ad is not placed unless it satisfies all m constraints.
(7) Let Pr(click|i,j(1), . . . j(K),c) be the probability the individual clicks on the ad given that the ad is at location i, the user has characteristics c and the ad has elements j(1), . . . j(K). And Pr(no-click|i,j(1), . . . j(K),c)=1−Pr(click|i,j(1), . . . .j(K),c).
   Bayes' Rule allows Pr(click|i,j(1), . . . j(K),c) to be written as [Pr(i,j(1 ), . . . j(K)|c,click)Pr(click|c)] divided by [Pr(i,j(1), . . . j(K)|c,click) Pr(click|c)+Pr([Pr(i,j(1), . . . j(K)|c,click)Pr(click|c,no-click)Pr(no-click|c)].
   To simplify data-gathering, assume Pr(i,j(1), . . . j(K)|c,click is equal to the product of Pr(i,j(k)|c,click) for k=1 . . . K and Pr(i,j(1), . . . j(K)|c,click is equal to the product of Pr(i,j(k)|c,no-click) for k=1 . . . K. Creating the ad and placing it is equivalent to specifying whether B(i,j(1), . . . j(K),c) equals 0 or 1. To solve for this variable, solve the integer program.
(8) Choose B(l,j(1), . . . ,j(K),c) for all l,j(1), . . . ,j(K),c to maximize the sum of B(i,j(1 ), . . . j(K),c) Pr(click|i,j(1), . . . j(K),c), which is subject to the following three constraints:
(8a) Σ_{j(r)=1 . . . max(r)}B(i,j(1), . . . j(K),c)=1 for each i,c and for all r=1 to K since only one choice can be made for each element of the ad and subject to B(i,j(1), . . . j(K),c) being a zero-one variable.
(8b) Σ_{i=1 . . . l} B(i,j(1), . . . j(K),c)=1 to assure that the ad is placed at exactly one and only one location.
(8c) π Rₙ(j(1), . . . j(K))=1 for n=1 . . . m; that is the ad is not placed unless it satisfies all m constraints.

There is a special case for the above cases where K=1, i.e., there is only one ad element. This is the case when the one element is itself a predefined ad and j(1) will return some number ranging from 1 to max where max is the total number of predefined ads stored in a database. In this case, then B(i,j(1),c) refers to one of those ads being selected to present to an individual based on characterization c of that individual. If c includes geo-demographic information obtained by reference to the user's location, then the procedure above is used to select one of several ads that is relevant to that user. For example, in some zip codes, it may be known that non-luxury midsize sedans dominate and k(1) might then pick out an ad for non-luxury sedan, whereas if c were based on a different user zip code, where luxury cars predominate, then k(1) might select an ad for a luxury sedan. Similarly, if c were based on the user's click stream and that click stream revealed that the user has been visiting web sites for hunting and fishing, then j(1) might select an ad for a pickup truck.

There is a zero-one integer program or binary integer program. (This problem could potentially be viewed as a generalization of a standard integer programming problem, called the matching problem, where each web-site ad is to be uniquely associated with some ad design.) But in this case, a particular ad design (defined by a particular combination of ad elements) could be associated with several web-site ads. Solving general zero-one integer programming problems is non-trivial (or NP-hard), i.e., the solution time potentially increases exponentially with maxₖ, K and N. Unfortunately, this optimization problem (or at least some parts of the optimization problem) must be solved in real-time, (while others can be solved off-line.) This differentiates the solution procedure for this problem formulation from the many integer programming heuristics used in the literature.

A specific example is now presented to illustrate the use of the above procedure. Various assumptions and states are given.

An ad database consists of just three ad element types: vehicle pictures, text messages and solid backgrounds. There are two pictures of a vehicle, a Chevrolet Malibu and Chevrolet Silverado. There are three choices for messages. The first message is “The best fuel economy in its class”, the second is “Like a Rock”; and the third is “The highest quality midsize sedan in America”. There are three backgrounds. The first is blue, the second is green and the third is white.

Restriction to just one ad placement location i is provided. The user characterization vector is populated with the zip code (obtained via the user's IP address), vehicle segment shares in that zip code, geo-demographic data for that zip code, and other information. The geo-demographic data for each zip code includes such information as average income and education, high employment categories (e.g. aerospace, farming, etc), and so forth.

Suppose there are two users and from their IP addresses the system determines that one of them is in zip code 90401 for Santa Monica, Calif. and the other is in zip code 59211 for Antelope, Mont. Refer to the user in California with the vector c1 and the user in Montana with vector c2.

When solving the integer program step (8) above for the two users gives:
(9) Σ B(i,j(1),j(2),j(3),c1) Pr(click|i,j(1),j(2),j(3),c1) or
(10) Σ B(i,j(1),j(2),j(3),c2) Pr(click|i,j(1),j(2),j(3),c2)

Assuming that the midsize car segment is somewhat larger in Santa Monica and the pickup truck segment is larger in Montana, then solving step (9) will result in an ad that selects the Chevy Malibu since users are much more likely to click on sedans in Santa Monica than pickups.

There may still be a number of potential ads all involving the Malibu because that vehicle needs to be combined with a message and a background. However, not all logically possible ads will be meaningful in the context of the constraints R described above in step (5). For example, one of these constraints, say R1, will assure that the message “Like a Rock” is only used for Silverados. This is an example of a business constraint. Thus, the Malibu will be restricted to ads where it appears in combination with the message “The best fuel economy in its class” or “The highest quality midsize sedan in America”. And each of these pairings can occur also with each of the backgrounds blue, green and white.

Another constraint R2 may state that the color of the text messages must be different from the color of the background, which is necessary in order for the targeted recipient of the ad to be able to actually read the text. Still other constraints will assure that the text is layered on top of the vehicle, so as not to be obscured by the vehicle, and so forth. These are all examples of constraints that are more aesthetic in nature, but must still be satisfied in order for the ad to be placed.

Depending on the actual preferences of people in zip code area 90401, the various ads with either the quality of the fuel economy message will emerge as more likely when solving step (9), and likewise for the background colors. If there are no significant differences in preferences for background color (or any other element), then one can be selected at random.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for creating personalized advertisements, said method comprising:
identifying a potential customer;
taking steps to understanding the potential customer;
designing and creating an advertisement for the potential customer that includes selecting several ad components for the advertisement from a database of ad components that may appeal to the potential customer based on the understanding of the potential customer where several selections for each ad component type are available in the database; and
placing and scheduling the advertisement in a user active medium.

2. The method according to claim 1 wherein understanding the potential customer includes determining the location of the customer.

3. The method according to claim 1 wherein understanding the customer includes identifying websites that the customer has visited.

4. The method according to claim 1 wherein designing and creating the advertisement includes designing and creating a vehicle advertisement.

5. The method according to claim 4 wherein designing and creating the advertisement includes selecting an ad component from one or more of vehicle photographs, vehicle back-drops, vehicle messages, vehicle facts, audio and dealerships.

6. The method according to claim 1 wherein designing and creating the advertisement includes considering ad rules and constraints.

7. The method according to claim 6 further comprising applying custom routines if one or more constraints are not satisfied that attempt to manipulate the ad structure by modifying parameter values until all of the constraints are satisfied.

8. The method according to claim 1 wherein designing and creating the advertisement includes considering corporate and brand objectives.

9. The method according to claim 1 further comprising measuring the effectiveness of the advertisement.

10. The method according to claim 9 further comprising using measurements of the effectiveness of the advertisement to improve the understanding of future potential customers.

11. A method for creating a personalized advertisement for a vehicle directed at a potential customer, said method comprising:
understanding the potential customer by identifying the potential customer's location, websites that the potential customer has visited, clicks within the website, forms the potential customer has filled out, and certain customer interests;
designing and creating an advertisement for the potential customer that includes selecting several ad components from a database of ad components that may appeal to the potential customer based on the understanding of the potential customer where each ad component type includes a plurality of selections; and
placing and scheduling the advertisement in a user active medium to be viewed and/or by the potential customer.

12. The method according to claim 11 wherein designing and creating the advertisement includes selecting an ad component from one or more of vehicle photographs, vehicle back-drops, vehicle messages, vehicle facts, audio and dealerships.

13. The method according to claim 11 wherein designing and creating the advertisement includes considering ad rules and constraints.

14. The method according to claim 11 further comprising applying custom routines if one or more constraints are not satisfied that attempt to manipulate the ad structure by modifying parameter values until all of the constraints are satisfied.

15. The method according to claim 11 wherein designing and creating the advertisement includes considering corporate and brand objectives.

16. The method according to claim 11 further comprising measuring the effectiveness of the advertisement.

17. A system for automatically creating personalized advertisements for a vehicle directed to a potential customer, said system comprising:
means for taking steps to understand the potential customer;
means for designing and creating an advertisement for the potential customer that includes selecting several ad components for the advertisement from a database of components that may appeal to the potential customer based on the understanding of the potential customer where several selections for each component are available on the database; and
means for placing and scheduling the advertisement in a user active medium.

18. The system according to claim 17 wherein the means for taking steps to understanding the potential customer includes means for determining the location of the potential customer, means for determining websites that the customer has visited and what clicks the customer has made within the website, and means for determining what forms the potential customer has filed out, said means for taking steps to understanding the potential customer also includes means for generating a customer profile from the information.

19. The system according to claim 17 wherein the means for designing and creating the advertisement includes means for considering ad rules and constraints.

20. The system according to claim 17 further comprising means for applying custom routines if one or more constraints are not satisfied that attempt to manipulate the ad structure by modifying parameter values until all of the constraints are satisfied.

21. The system according to claim 17 wherein the means for designing and creating the advertisement includes means for considering corporate and brand objectives.

22. The system according to claim 17 wherein the means for designing and creating the advertisement includes means for selecting an ad component from each of vehicle photographs, vehicle back-drops, vehicle messages, vehicle facts, audio and dealerships.

23. The system according to claim 17 further comprising means for measuring the effectiveness of the advertisement.
